(19) United States
(12) Patent Application Publication
(10) Pub. No.: US 2011/0087467 A1
(43) Pub. Date: Apr. 14, 2011

(54) Method, device and computer program for planning an aspirative fire detection system

(75) Inventor: Oliver Linden, Hannover (DE)

(73) Assignee: AMRONA AG, Zug (CH)

(21) Appl. No.: 12/923,827

(22) Filed: Oct. 8, 2010

(30) Foreign Application Priority Data
Oct. 9, 2009 (EP) 09172716.4

(51) Int. Cl. G06F 17/50

(52) U.S. Cl. 703/1

(57) ABSTRACT

The present invention relates to a method, a device and a computer program for planning an aspirative fire detection system having a detector module and a pipe system. In order to be able to plan an aspirative fire detection system in an easily-realized yet effective manner, the invention provides for planning the detector module with the aid of a planning table and planning the pipe system with the aid of a pipe planning table.

### CROSS-REFERENCE TO RELATED APPLICATIONS

The present application claims priority from European Patent Application No. 09172716.4, filed Oct. 9, 2009, the contents of which are herein incorporated by reference in their entirety.

### BACKGROUND OF THE INVENTION

1. Field of the Invention

The invention relates to a method, device and computer program for planning an aspirative fire detection system.

2. Description of the Related Art

An aspirative fire detection system is designed to extract representative air samples from a closed room, for example a warehouse or an IT server room, either continuously or at predetermined times or upon predetermined events, and feed them to a detector module. The detector module serves to identify the physical or chemical properties of the supplied air samples so as to allow a conclusion to be drawn from said properties as to the chemical or physical state of the air within the closed room.

FIG. 1 shows a schematic representation of one embodiment of an aspirative fire detection system. A pipe system 102 is arranged in a target room 101 to aspirate air samples through various intake openings. The pipe system 102 is equipped with an aspiration detector into which the air samples from the target room 101 are fed to a detector module 103 to detect fire characteristics, respectively to measure oxygen and other gases. A fan 104 is furthermore provided, serving to suck in the air samples from the target room through the pipe system. The suction power of fan 104 is thereby adapted to the respective pipe system 102.

To be understood by the term “fire characteristic” are physical parameters subject to measurable changes in the vicinity of a fire; e.g. the ambient temperature or the percentage of solids, liquids or gases in the ambient air such as smoke particles, smoke aerosols, vapor or fumes, for example.

Typical areas of application for aspirative fire detection systems are in the monitoring of spaces such as e.g. double floors, false ceilings, tunnels, ducts, poorly accessible hollow spaces, warehouse storage areas, high-bay warehouses, elevator shafts, museums, cultural facilities, freezer warehouses, air-conditioning systems and also the monitoring of rooms containing high value or important equipment such as e.g. rooms housing data processing equipment inside banks or other such similar facilities, or even the data processing equipment itself. To this end, representative portions of the room air or the cooling air are continuously extracted, these being referred to as air samples. The air samples are extracted through a pipe system which is mounted e.g. below the ceiling.

In order to ensure effective monitoring of the respective room, aspirative fire detection systems need to be individually designed, i.e. planned, depending upon the size and the type of room to be monitored and the respective purpose of monitoring. Different parameters need to be considered in such planning including the desired responsivity (sensitivity) of the fire detection system, the size and configuration of the pipe system, and the number of intake openings in the pipe system. The optimal planning of a fire detection system is characterized by the components of the fire detection system, in particular the detector module and the pipe system, being adapted to the size and type of room to be monitored on the one hand and to the desired responsivity for the room monitoring on the other; i.e. neither overdimensioned nor underdimensioned. Due to the plurality of parameters to be considered, optimal planning is a relatively complex problem which, in practice, creates considerable difficulties for one skilled in the art.

### SUMMARY OF THE INVENTION

Based on this problem as defined, the task of the present invention is thus specifying a suitable and efficient method as well as a device and a computer program for planning an aspirative fire detection system.

This task is solved by a method for planning an aspirative fire detection system having a detector module and a pipe system, wherein the method comprises the following steps: planning the detector module with the aid of at least one planning table; and planning the pipe system with the aid of at least one pipe planning table. This task is further solved with a device for planning an aspirative fire detection system having a detector module and a pipe system, wherein the device comprises the following: means for planning the detector module with the aid of at least one planning table; and means for planning the pipe system with the aid of at least one pipe planning table. Finally, this task is further solved with a computer program which includes instructions furnished to perform a method for planning an aspirative fire detection system having a detector module and a pipe system, wherein the method comprises the following steps: planning the detector module with the aid of at least one planning table; and planning the pipe system with the aid of at least one pipe planning table; or set up a device for planning an aspirative fire detection system having a detector module and a pipe system, wherein the device comprises the following: means for planning the detector module with the aid of at least one planning table; and means for planning the pipe system with the aid of at least one pipe planning table when run on a computer. Advantageous embodiments are described in the following Description.

With respect to the method for planning an aspirative fire detection system, the invention provides for planning the detector module of the fire detection system with the aid of at least one planning table on the one hand and planning the pipe system of the fire detection system with the aid of at least one pipe planning table on the other. The planning table and the pipe planning table enable the detector module and the pipe system to be easily, quickly and cost-efficiently dimensioned to the respective application scenario.

The detector module planning step preferably includes the following steps: selecting a number of intake openings and determining the sensitivity class to be achieved for the fire detection system based on the planning table and the number of intake openings. The detector module planning step can additionally include the step of selecting a desired sensitivity class and determining the required responsivity for a detector module in order to achieve the desired sensitivity class. The step of selecting the detector module based on the required responsivity and determining a sensitivity setting for the detector module based on the given detector module and the required responsivity can likewise be provided.

This procedure has the advantage of basing achievable sensitivity classes on one central influencing factor, namely the number of intake openings. Because depending on the number of intake openings, the A, B and C sensitivity classes pursuant the European EN 54-20 standard can be achieved with any given detector module. Determining the number of intake openings early on enables the achievable sensitivity classes to be easily and efficiently specified using the planning table. The desired sensitivity class can then be selected therefrom. Afterwards, a suitable detector module and an appropriate sensitivity setting can be easily and efficiently determined with the aid of the planning table.

The inventive planning method preferably further comprises the following steps: selecting an air filter and defining a planning table and/or a pipe planning table based on the air filter. The question of whether and what type of air filter is provided has a considerable influence on the design of the overall system. It is therefore expedient to provide for a different planning table depending on the type of air filter selected.

In one preferred embodiment of the inventive solution, the pipe system planning step includes the following steps: selecting a desired pipe length, selecting a pipe shape based on the pipe length and the pipe planning table, and selecting a fan voltage based on the pipe length and shape. These steps enable the pipe system to be planned easily and quickly with the aid of the pipe planning table.

In one preferred realization of the inventive method, same comprises the following steps: selecting a desired class of pipe accessories and determining a pipe planning table based on the pipe accessory class. The step of selecting a desired pipe accessory class can hereto encompass the step of selecting one or more components from the component group comprising condensate separators, detonation arrestors, valve control unit shut-off valves, detector boxes, sound suppressors and aspiration detectors. By the providing of a plurality of differing pipe planning tables which, depending upon the desired pipe accessory class, ultimately define the air resistance class, planning the pipe system is easy and simple. The air resistance classes can thereby relate to, for example, the “without pipe accessories,” “slightly increased air resistance,” “increased air resistance” or “high air resistance” classes.

The invention furthermore relates to a device for planning an aspirative fire detection system having a detector module and a pipe system, wherein the device comprises a means for planning the detector module with the aid of a planning table and a means for planning the pipe system with the aid of a pipe planning table. The planning table and pipe planning table enable easy and efficient planning.

The means for planning the detector module preferably comprises a means for selecting a number of intake openings and a means for determining the achievable sensitivity classes based on the planning table and the number of intake openings. The means for planning the detector module can further comprise a means for selecting a desired sensitivity class, a means for determining a required responsivity for a detector module to achieve the desired sensitivity class, a means for selecting the detector module based on the required sensitivity and/or a means for determining a sensitivity setting for the detector module based on the detector module and the required sensitivity. In this way, a suitable detector module and its sensitivity setting can be quickly and easily determined on the basis of the planning table and the number of intake openings.

In one preferred embodiment, the device according to the invention comprises a means for selecting an air filter and a means for determining a planning table and/or a pipe planning table based on the air filter. Since the selection of the air filter can have considerable influence on the planning, providing a plurality of planning tables and the determination of same based on the selected air filter can result in simple and efficient planning.

In one preferred embodiment, the means for planning the pipe system comprises a means for selecting a desired pipe length, a means for selecting a pipe shape based on the pipe length and the pipe planning table, and a means for selecting a fan voltage based on the pipe length and shape. This embodiment enables simple and quick planning of the pipe system.

The device according to the invention preferably comprises a means for selecting a desired pipe accessory class and a means for determining a pipe planning table based on the pipe accessory class. The means for selecting a desired pipe accessory class can thereby comprise a means for selecting one or more components from the component group comprising condensate separators, detonation arrestors, valve control unit shut-off valves, detector boxes, sound suppressors and aspiration detectors. Planning the pipe system depends to a considerable degree on the pipe accessory class. Providing a plurality of pipe planning tables based on the pipe accessory class to be used during the planning stage can achieve simple and efficient planning of the pipe system.

The described inventive method and inventive device can be accomplished or set up by means of a computer program. Hence, the invention further relates to a computer program which includes instructions furnished to perform the inventive method or set up an inventive device when run on a computer.

### BRIEF DESCRIPTION OF THE DRAWINGS

The following will reference the accompanying drawings in describing an embodiment of the invention in greater detail.

Shown are:

FIG. 1 is a schematic view of an aspirative fire detection system;

FIG. 2 is a flow chart to illustrate an embodiment of the inventive method of planning an aspirative fire detection system, e.g. as according to FIG. 1;

FIG. 3 is a list of possible air filter types for use in an aspirative fire detection system, e.g. as in accordance with FIG. 1;

FIG. 4a is an embodiment of a planning table for planning a fire detection system without an air filter;

FIG. 4b is an embodiment of a pipe planning table for planning a fire detection system without an air filter when no other pipe accessory is used;

FIG. 4c is an embodiment of a pipe planning table for planning a fire detection system without an air filter when a detector box and/or a valve control unit is/are used as pipe accessory/accessories;

FIG. 4d is an embodiment of a pipe planning table for planning a fire detection system without an air filter when an aspiration detector or condensate separator is used as a pipe accessory;

FIG. 4e is an embodiment of a pipe planning table for planning a fire detection system without an air filter when a detonator arrestor is used as a pipe accessory;

FIG. 5a is an embodiment of a planning table for planning a fire detection system having an LF-AD type air filter;

FIG. 5b is an embodiment of a pipe planning table for planning a fire detection system having an LF-AD air filter when no other pipe accessory is used;

FIG. 5c is an embodiment of a pipe planning table for planning a fire detection system having an LF-AD air filter when a detector box and/or a valve control unit is/are used as pipe accessory/accessories;

FIG. 5d is an embodiment of a pipe planning table for planning a fire detection system having an LF-AD air filter when an aspiration detector or condensate separator is used as a pipe accessory;

FIG. 5e is an embodiment of a pipe planning table for planning a fire detection system having an LF-AD air filter when a detonation arrestor is used as a pipe accessory;

FIG. 6a is an embodiment of a planning table for planning a fire detection system having an LF-AD-1 type air filter;

FIG. 6b is an embodiment of a pipe planning table for planning a fire detection system having an LF-AD-1 air filter when no other pipe accessory is used;

FIG. 6c is an embodiment of a pipe planning table for planning a fire detection system having an LF-AD-1 air filter when a detector box and/or a valve control unit is/are used as pipe accessory/accessories;

FIG. 6d is an embodiment of a pipe planning table for planning a fire detection system having an LF-AD-1 air filter when an aspiration detector or condensate separator is used as a pipe accessory;

FIG. 6e is an embodiment of a pipe planning table for planning a fire detection system having an LF-AD-1 air filter when a detonation arrestor is used as a pipe accessory;

FIG. 7a is an embodiment of a planning table for planning a fire detection system having an LF-AD-2 type air filter;

FIG. 7b is an embodiment of a pipe planning table for planning a fire detection system having an LF-AD-2 air filter when no other pipe accessory is used;

FIG. 7c is an embodiment of a pipe planning table for planning a fire detection system having an LF-AD-2 air filter when a detector box and/or a valve control unit is/are used as pipe accessory/accessories;

FIG. 7d is an embodiment of a pipe planning table for planning a fire detection system having an LF-AD-2 air filter when an aspiration detector or condensate separator is used as a pipe accessory;

FIG. 7e is an embodiment of a pipe planning table for planning a fire detection system having an LF-AD-2 air filter when a detonation arrestor is used as a pipe accessory;

FIG. 8a is an embodiment of a planning table for planning a fire detection system having an SF-400/SF-650 type air filter;

FIG. 8b is an embodiment of a pipe planning table for planning a fire detection system having an SF-400/SF-650 air filter when no other pipe accessory is used;

FIG. 8c is an embodiment of a pipe planning table for planning a fire detection system having an SF-400/SF-650 air filter when a detector box and/or a valve control unit is/are used as pipe accessory/accessories;

FIG. 8d is an embodiment of a pipe planning table for planning a fire detection system having an SF-400/SF-650 air filter when an aspiration detector or condensate separator is used as a pipe accessory;

FIG. 8e is an embodiment of a pipe planning table for planning a fire detection system having an SF-400/SF-650 air filter when a detonation suppressor is used as a pipe accessory;

FIG. 9 is the response sensitivity of three different detector modules; and

FIG. 10 shows different pipe shapes for a pipe system of a fire detection system.

### DESCRIPTION OF THE INVENTION

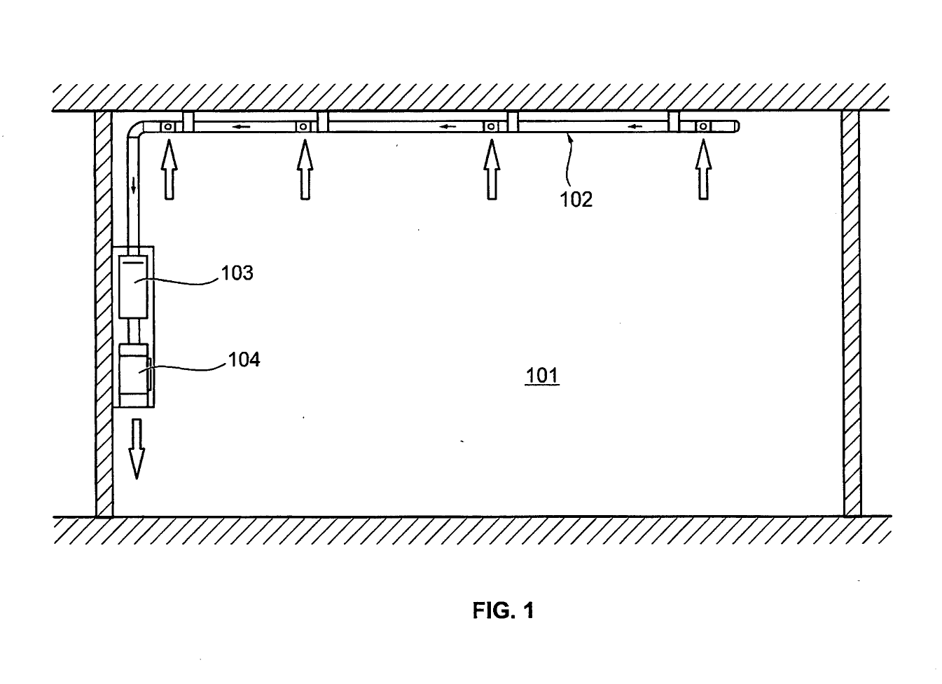

FIG. 1 shows a schematic representation of an embodiment of an aspirative fire detection system. A pipe system 102 to suck in air samples through various intake openings is disposed in a target room 101. The pipe system 102 is equipped with an aspiration detector in which the air samples from the target room 101 are fed to a detector module 103 to detect fire characteristics, respectively to measure oxygen and other gases. A fan 104 is further provided which serves to suck in the air samples from the target room through the pipe system 102. The suction power of the fan 104 is thereby adapted or adaptable to the respective pipe system 102.

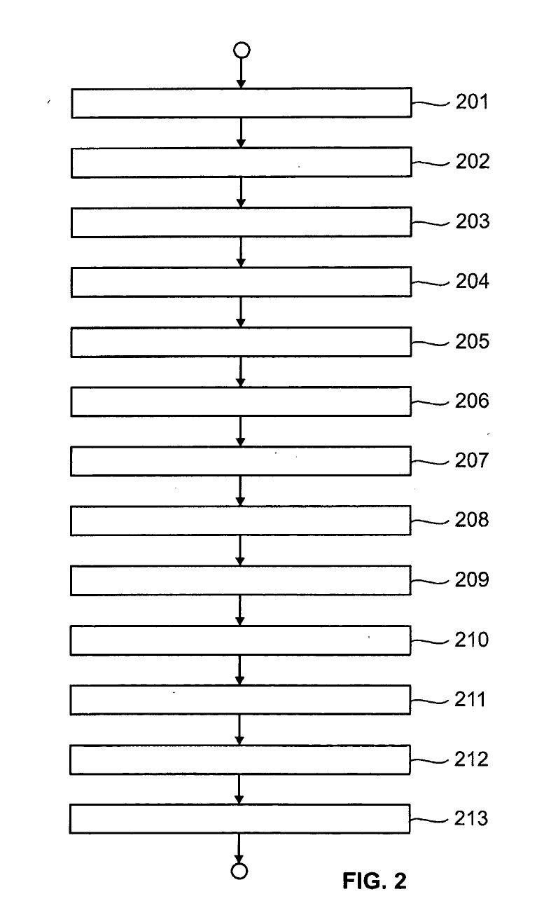

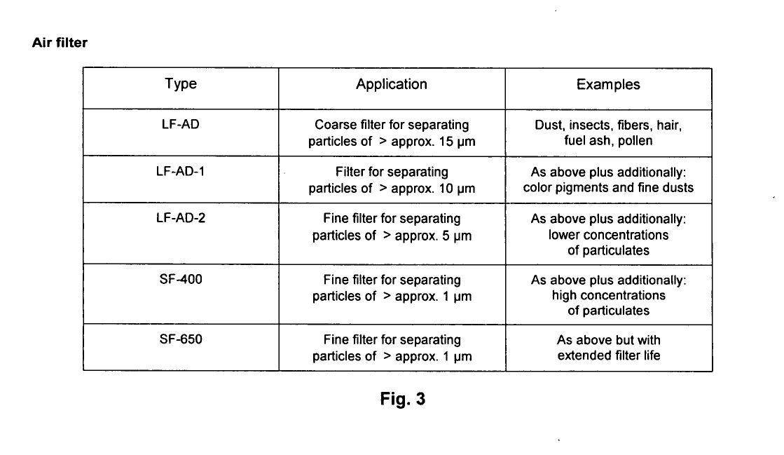

FIG. 2 shows a flow chart to illustrate an embodiment of the inventive method of planning an aspirative fire detection system, e.g. as in accordance with FIG. 1. An air filter type is selected in Step 201. Different types of example air filters from among which can be selected in Step 201 are listed in FIG. 3. These air filter types differ particularly with respect to the particle sizes which they filter. The LF-AD filter type filters particularly large particles, while the SF-650 filter can also filter very small particles out of the air, provided they are larger than 1 μm. The right column in FIG. 3 indicates common impurities of the indicated particle sizes.

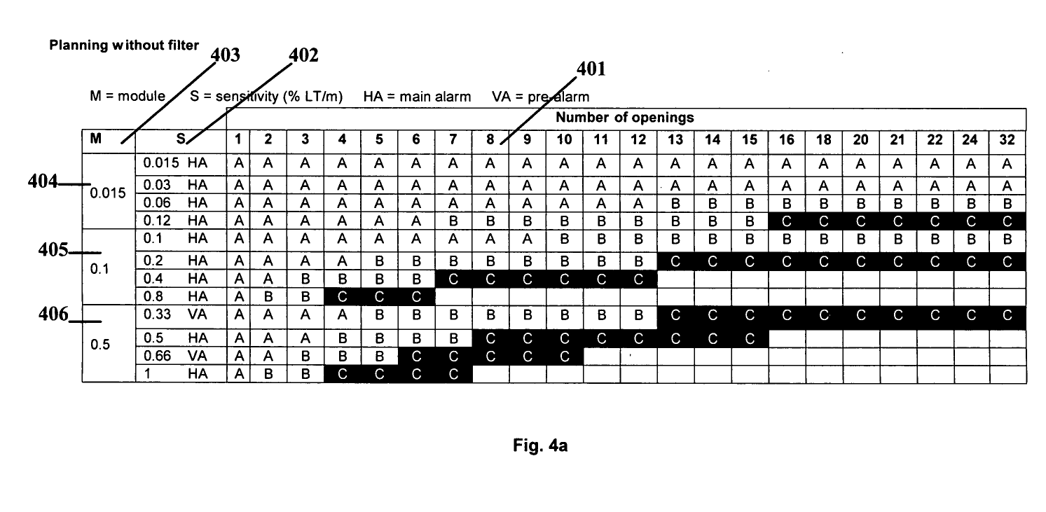

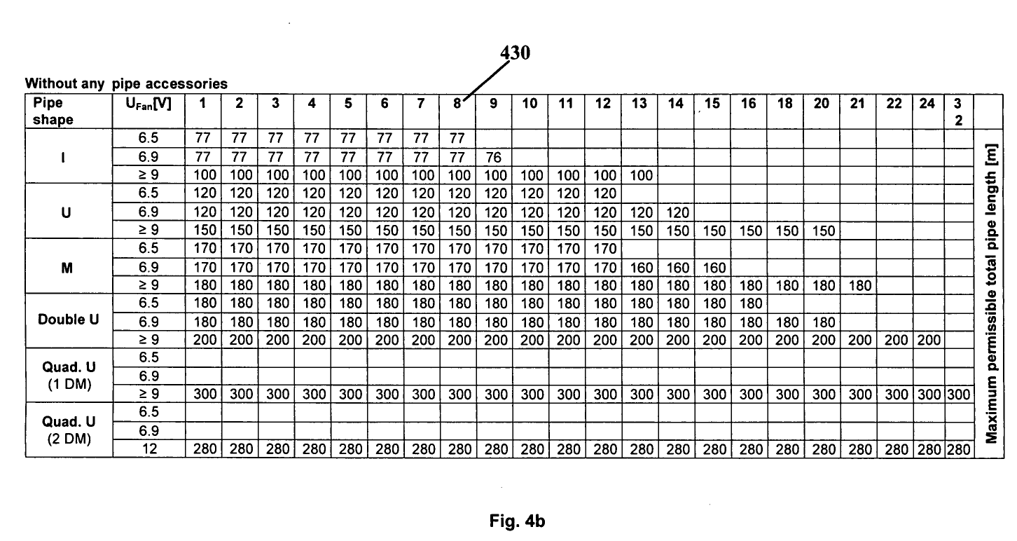

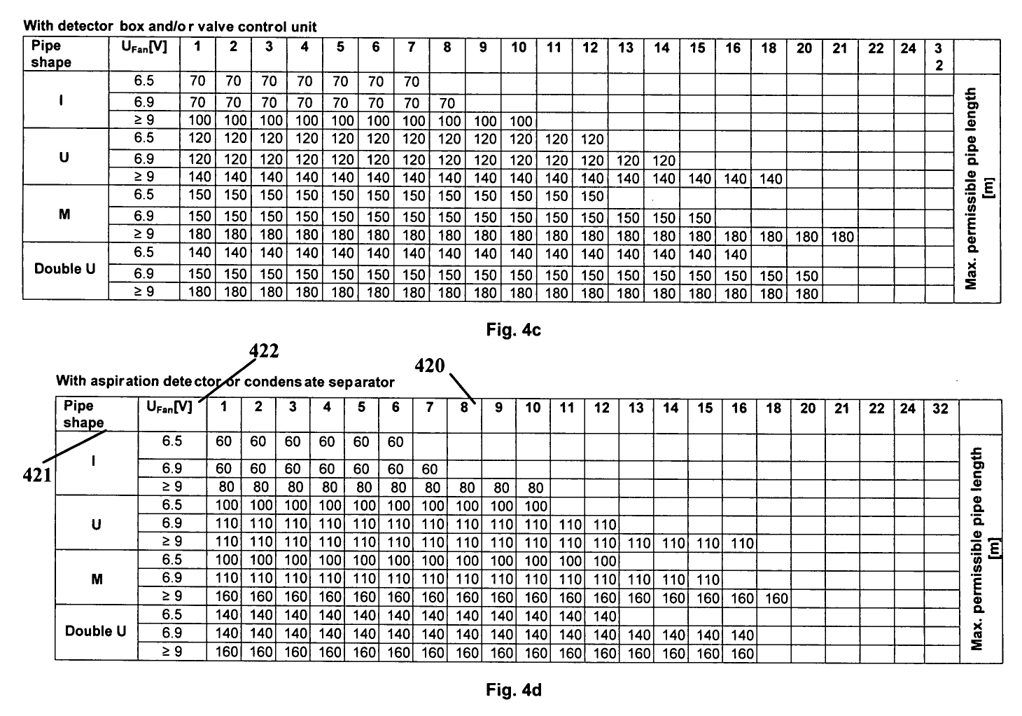

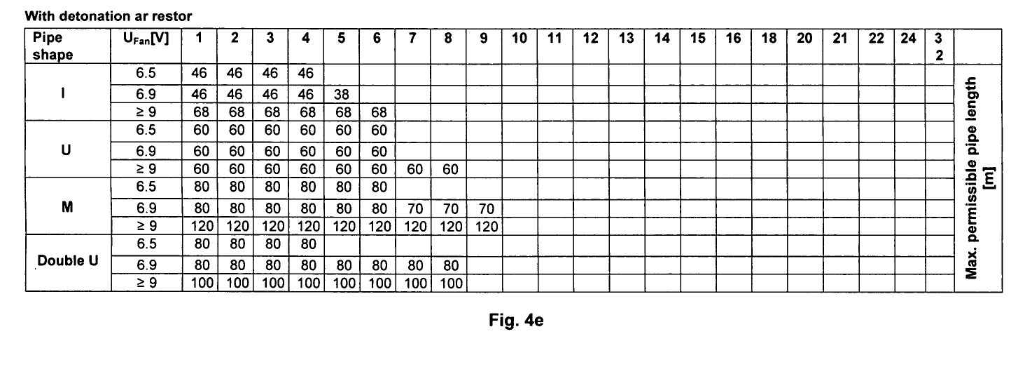

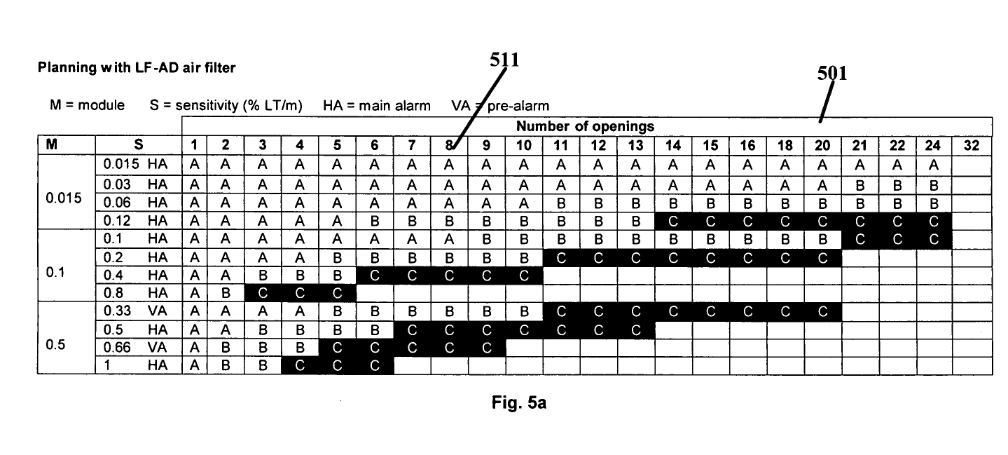

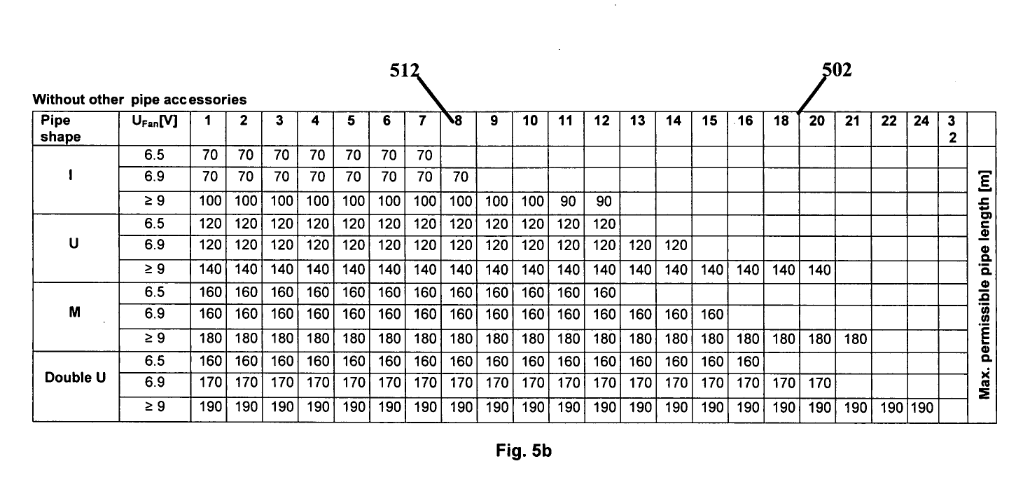

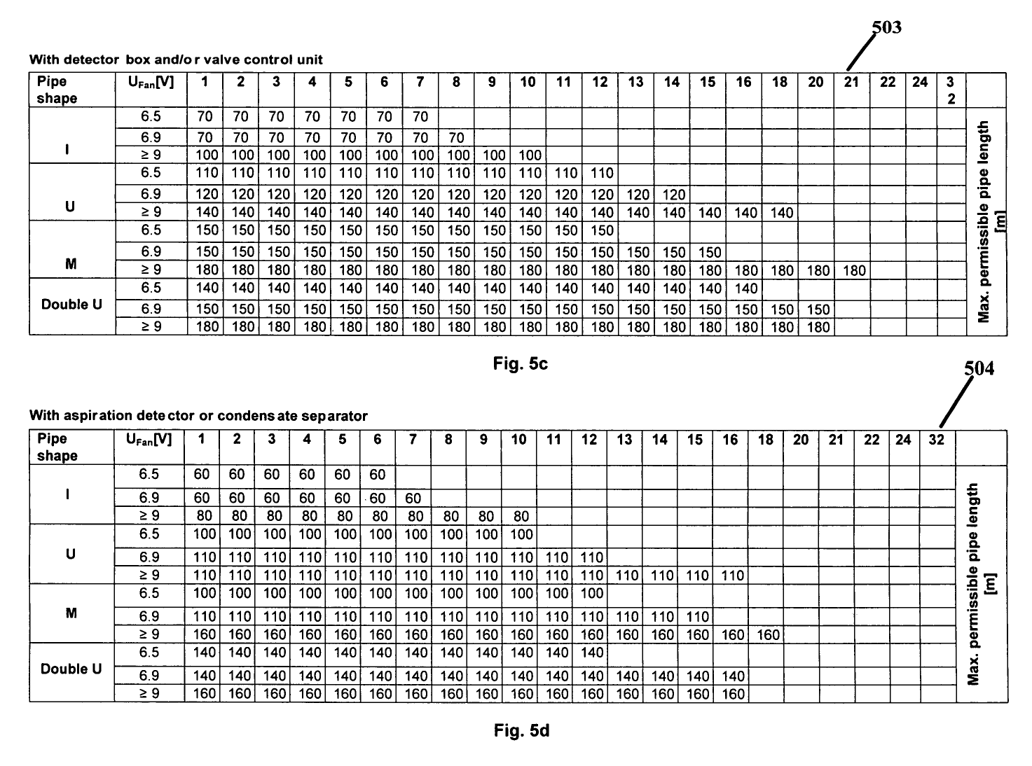

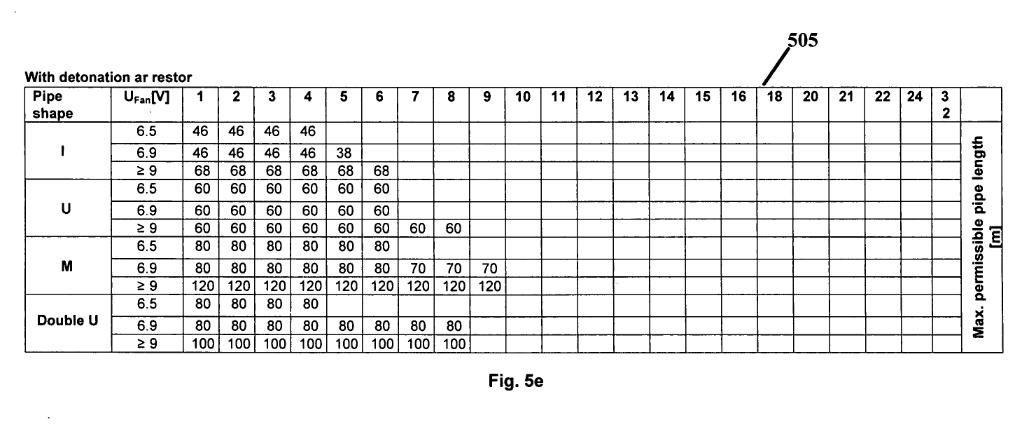

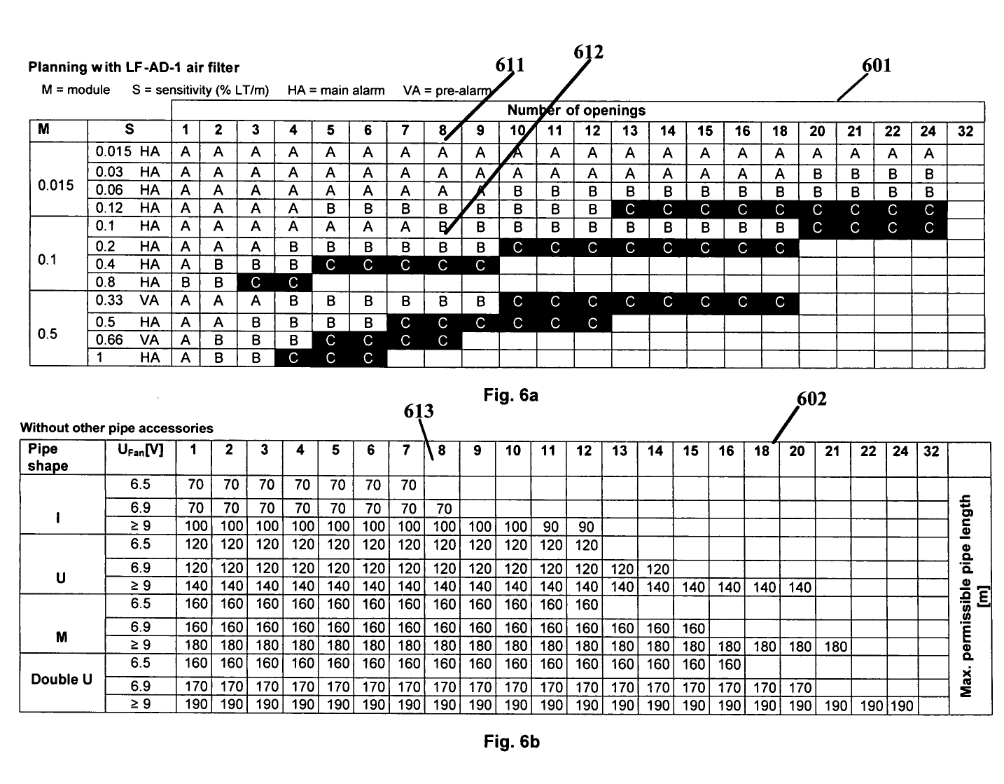

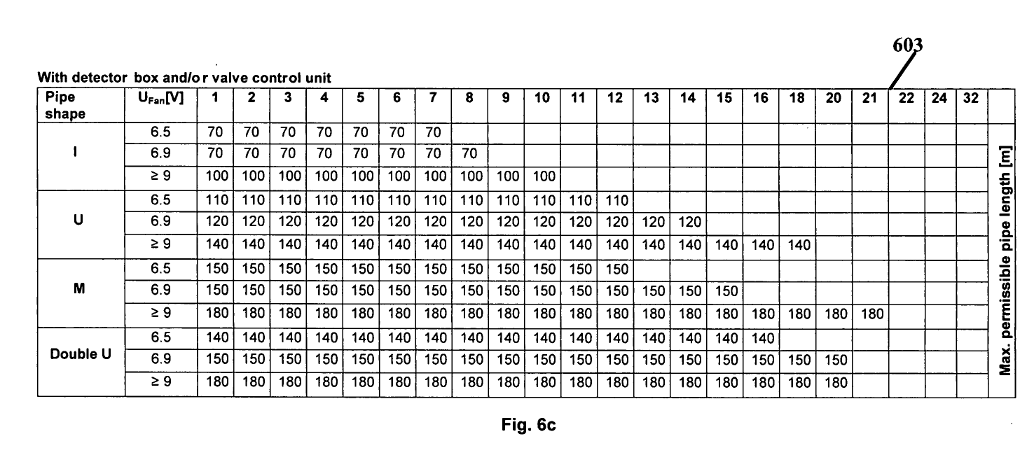

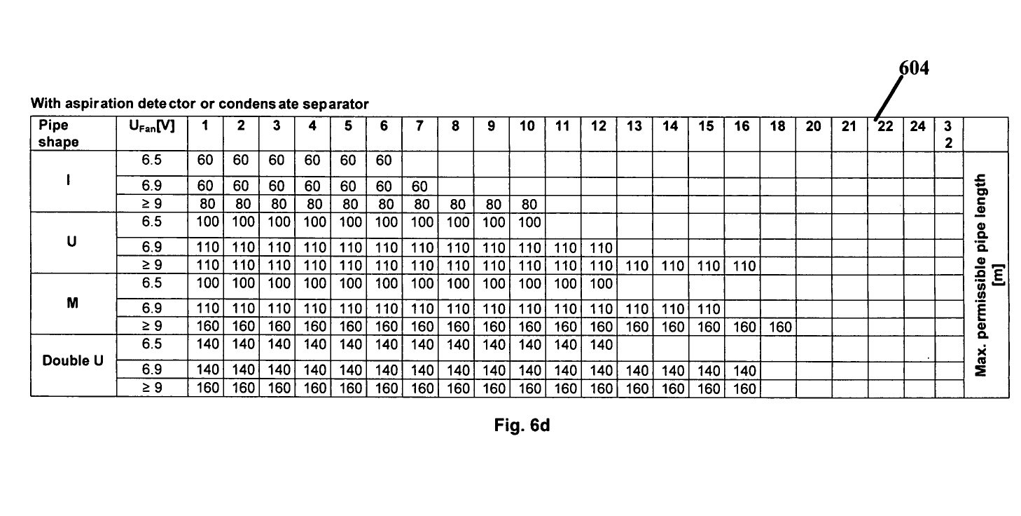

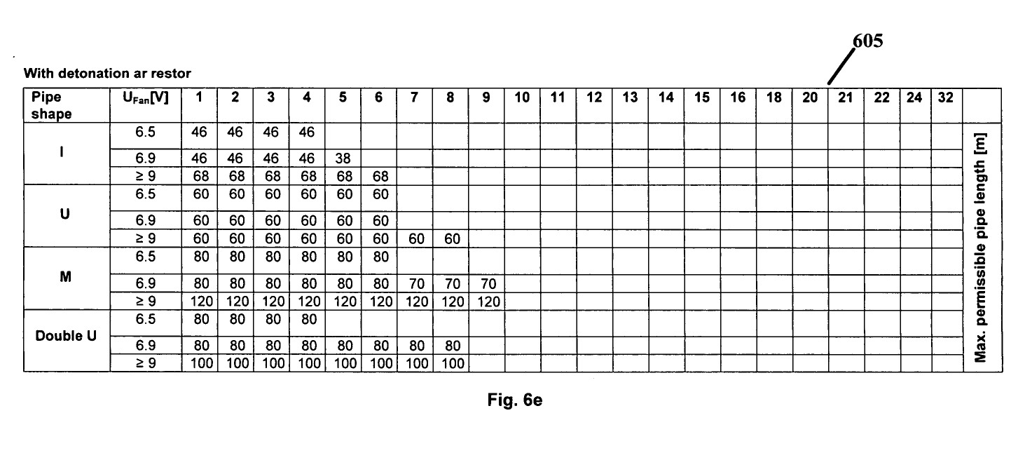

A planning table based on the selected air filter type is determined in Step 202. FIG. 4a shows an embodiment of a possible planning table. This planning table is to be used with the embodiment described here which indicates that no air filter will be used. On the other hand, the planning table and pipe planning table embodiments shown in FIGS. 5a to 5e are to be used when the LF-AD air filter is selected. FIGS. 6a to 8e meanwhile depict planning table and pipe planning table embodiments to be used when the LF-AD-1, LF-AD-2, SF-400 or SF-650 air filter types will be used.

Subsequently, a number of intake openings are selected for the pipe system in Step 203. For example, as depicted in FIG. 4a, eight intake openings could be selected for use (see column 401 in FIG. 4a).

In Step 204, the sensitivity classes to be obtained with the fire detection system are determined based on the planning table and the number of intake openings. The sensitivity classes are indicated in column 401 of FIG. 4a.

The European EN 54-20 standard indicates three sensitivity classes. Class A specifies aspirating smoke detectors having extremely high sensitivity. This extremely high sensitivity of Class A is necessary if fires are to be detected at a very early stage or in cases of significant smoke dilution which can occur for example when IT areas are air-conditioned. Class B is used for aspirating smoke detectors of increased sensitivity. The early detection of fire afforded by Class B results in gaining a considerable amount of time in detecting fire very early on. Class C specifies aspirating smoke detectors having normal sensitivity. Class C detects fires with a normal quickness such as that provided by point-type smoke detectors, for example.

A desired sensitivity class is selected in Step 205. The sensitivity of a detector module necessary to achieve the desired sensitivity class is indicated in column 402, shown in FIG. 4a. Based on the desired sensitivity class, the required sensitivity can thus be determined in Step 206. Based on the required sensitivity, a detector module is then selected in Step 207.

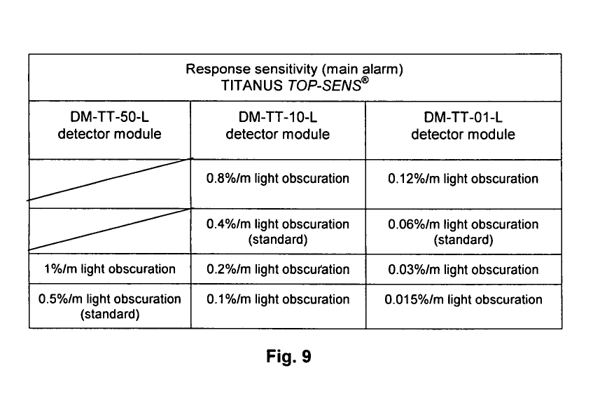

The modules are indicated in column 403 and correspond to the detector modules indicated in FIG. 9. Hence, the module indicated in line 404 corresponds to the DM-TT-01-L detector module type, the module indicated in line 405 corresponds to the DM-TT-10-L detector module type, and the module indicated in line 406 corresponds to the DM-TT-50-L detector module type.

Based on the required sensitivity, the suitable detector module can be selected in Step 207. The sensitivity setting for the detector module is determined in Step 208 based on the detector module and the required sensitivity.

The desired pipe accessory class for the pipe system is selected in Step 209. Primary accessories encompass condensate separators, valve control unit shut-off valves, detector boxes, detonation arrestors, aspiration detectors or sound suppressors, the selection of which has effects on the air resistance class.

A pipe planning table is determined in Step 210 based on the pipe accessory class. For example, FIG. 4b shows a pipe planning table used when no pipe accessories have been selected. The FIG. 4c pipe planning table is to be used when a detector box and/or valve control unit is included; the FIG. 4d table is used when there is an aspiration detector or condensate separator; the FIG. 4e table when a detonation arrestor has been selected. Noted in conjunction hereto is that the pipe planning tables of FIGS. 4b to 4e are only to be used when no air filter has been provided.

A desired pipe length is selected in Step 211. In one preferred embodiment of an aspirative fire detection system, the following limiting values are to be observed: the minimum pipe length between two intake openings is to amount to 4 m. The maximum pipe length between two intake openings is to amount to 12 m. The maximum total pipe length can amount to 300 m, respectively two times 280 m when there are two detector modules in two connected pipe systems. A maximum of 32 intake openings are possible per detector module.

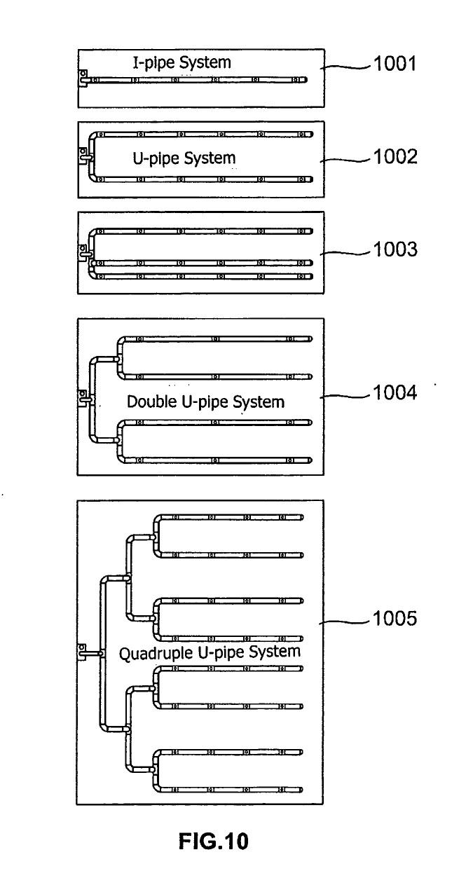

Column 420 of FIG. 4d shows an example of applicable pipe lengths when eight intake openings have been selected. A pipe shape is selected in Step 212 based on the pipe length and the pipe planning table. The pipe shapes are illustrated in FIG. 10. An I-pipe system 1001 is a smoke aspiration pipe system without any branches. A U-pipe system 1002 branches into two smoke aspiration pipe branches. The M-pipe system 1003 shown in FIG. 10 is characterized by forking into three smoke aspiration pipe branches. A Double U-pipe system 1004 consists of four smoke aspiration pipe branches and a Quadruple U-pipe system 1005 is a smoke aspiration pipe system which branches into eight smoke aspiration pipe branches.

After selecting the pipe shape, a fan voltage is selected in Step 213 based on the pipe length and shape. By so doing, the suction power of the fan is adapted to the pipe system. Various fan voltage examples are indicated in column 422 of FIG. 4d.

The above procedure according to FIG. 2 is illustrated by means of the tables shown in FIGS. 4a to 4e. For the sake of completeness, the following will address the embodiments of the planning and pipe planning tables shown in FIGS. 5a to 8e.

FIGS. 5a to 5e show a further embodiment of a planning table 501 as well as further embodiments of pipe planning tables. The tables shown are to be used when the LF-AD air filter is selected in Step 201. The pipe planning tables of FIGS. 5b to 5e are used contingent upon the desired pipe accessory class selected in Step 209. The pipe planning table 502 of FIG. 5b is to be used when the LF-AD air filter is selected and no further pipe accessory has been provided. If it was established in Step 209 that the pipe system is to contain a detector box and/or a valve control unit, pipe planning table 503 from FIG. 5c is then to be used. Pipe planning table 504 from FIG. 5d is used when an aspiration detector or a condensate separator is to be used. If a detonator arrestor has been selected, pipe planning table 505 from FIG. 5e is to be used.

As can readily be seen by comparing FIG. 5a or 5b with FIG. 4a or 4b, the selection of the LF-AD air filter has definite effects on the planning. While a comparison of column 511 with column 401 shows that the selection of the LF-AD air filter does not affect the achievable sensitivity classes, column 512 compared to column 430 discloses how when using the I-pipe form, for example, other pipe lengths are to be allowed for provided no further pipe accessories are used.

FIGS. 6a to 6e show embodiments of a planning table 601 and pipe planning tables which are to be used when the LF-AD-1 air filter is to be used. Without any further pipe accessories, the pipe planning table 602 from FIG. 6b is to be used; with a detector box and/or valve control unit (VSK), pipe planning table 603 from FIG. 6c is to be used; with an aspiration detector and/or condensate separator, pipe planning table 604 from FIG. 6d is to be used; and with a detonator arrestor, pipe planning table 605 from FIG. 6e is to be used.

As can be seen by comparing column 611 from FIG. 6a with column 401 from FIG. 4a, selecting the LF-AD-1 air filter results in differences in the sensitivity classes which can be obtained. For example, box 612 shows that when using the DM-TT-10-L detector module, only sensitivity class B can be achieved if the sensitivity setting is at 0.1% light obscuration per meter. Differences can also arise due to the pipe length, as can be seen by comparing column 613 in FIG. 6b to column 430 in FIG. 4b.

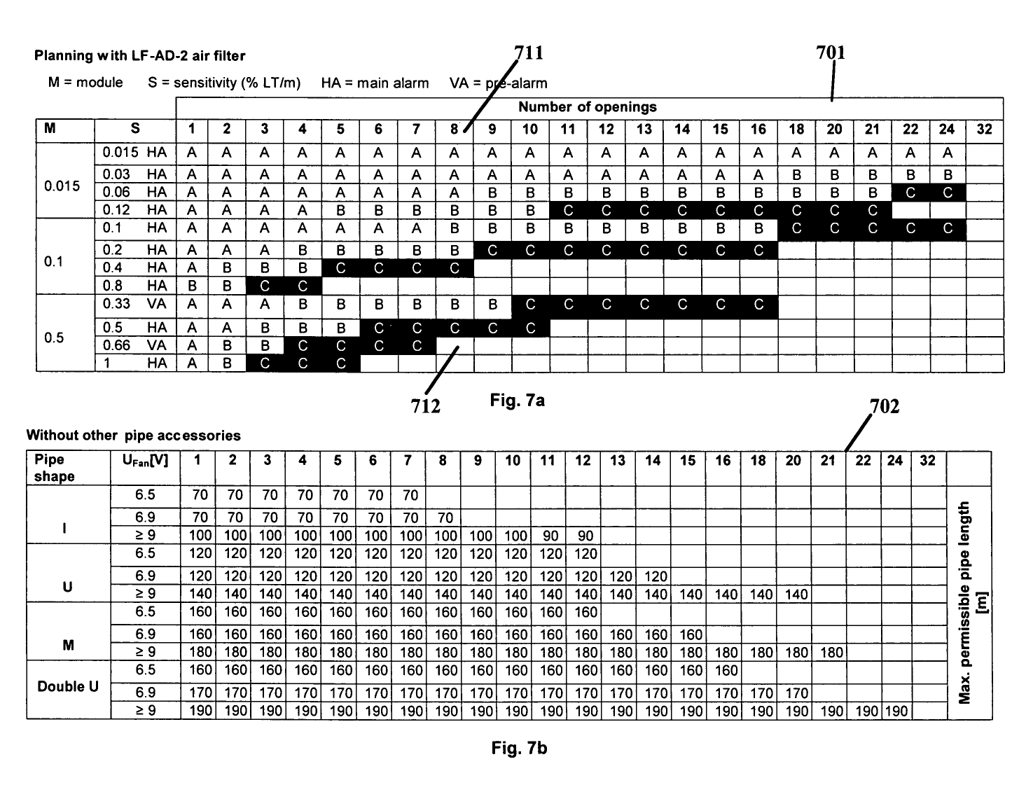

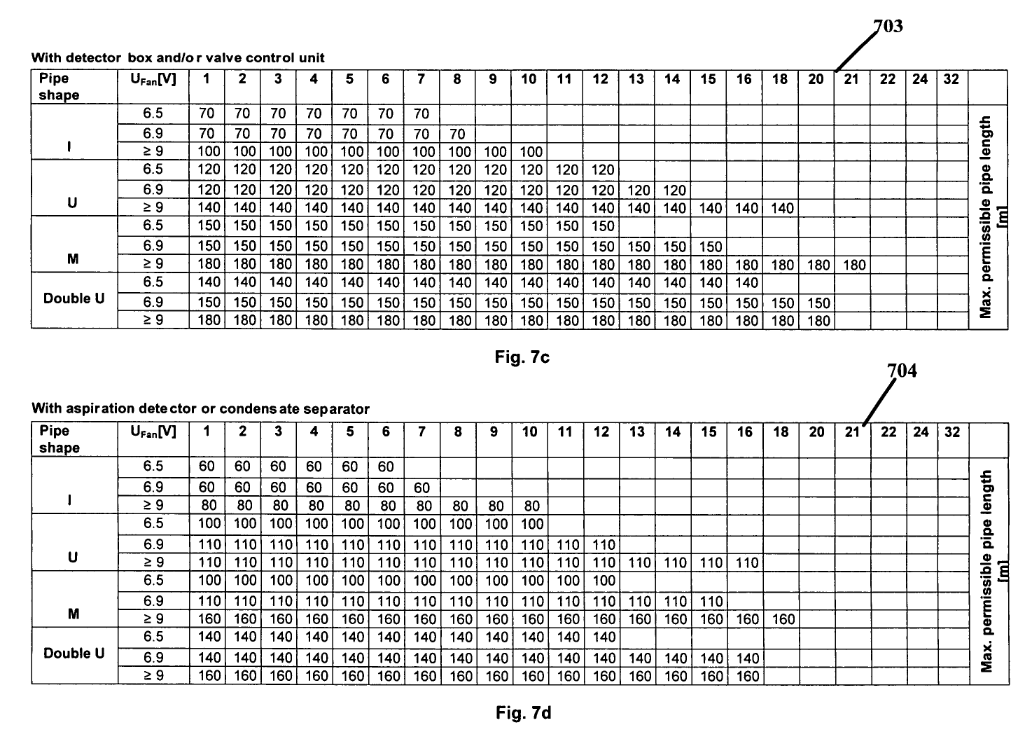

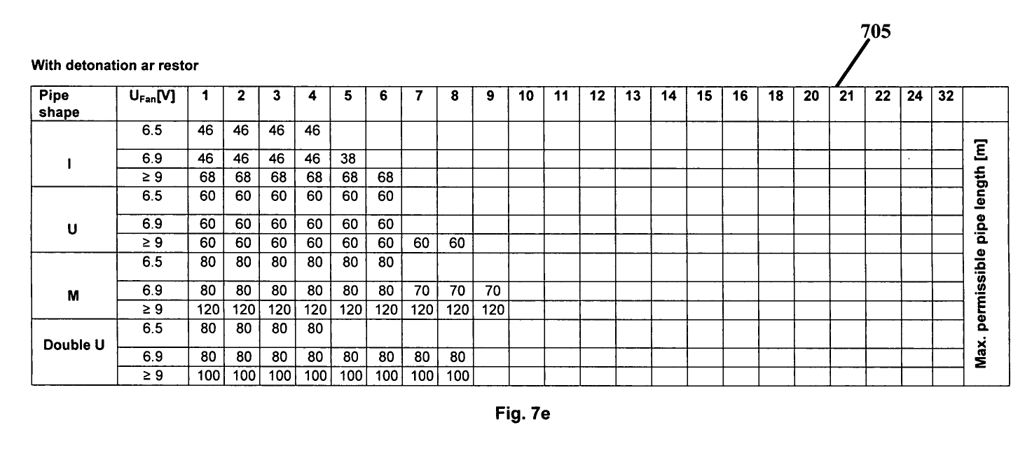

FIGS. 7a to 7e show further embodiments of a planning table 701 and pipe planning tables 702 to 705 which are to be used when the LF-AD-2 air filter has been selected. If planning is to be based on no further pipe accessories, the pipe planning table 702 from FIG. 7b is to be used. When a detector box and/or valve control unit is to be installed along with selection of an LF-AD-2 air filter, pipe planning table 703 from FIG. 7c is to be used. With an aspiration detector and/or condensate separator, pipe planning table 704 from FIG. 7d is to be used and with a detonator arrestor, pipe planning table 705 from FIG. 7e is to be used.

Comparing column 711 from FIG. 7a to column 401 from FIG. 4a shows that when using the DM-TT-50-L detector module with pre-alarm, sensitivity class C can no longer be obtained if the pre-alarm sensitivity is set at 0.66% light obscuration per meter (see Box 712 hereto).

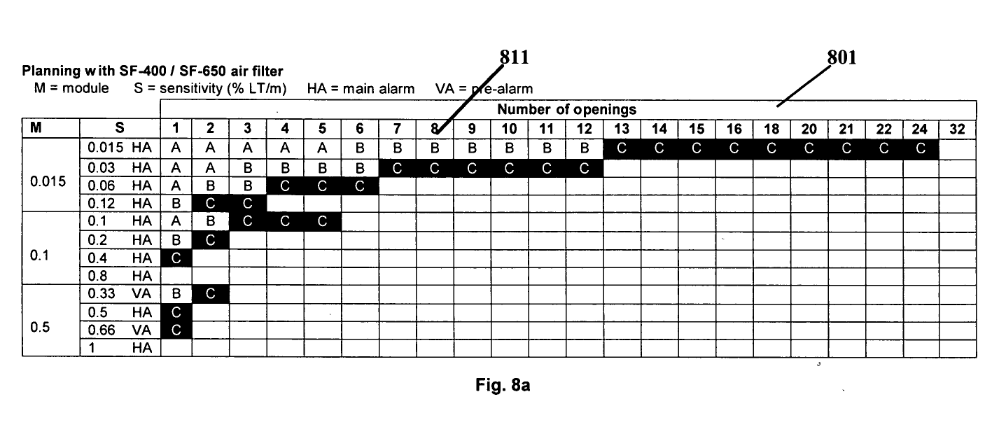

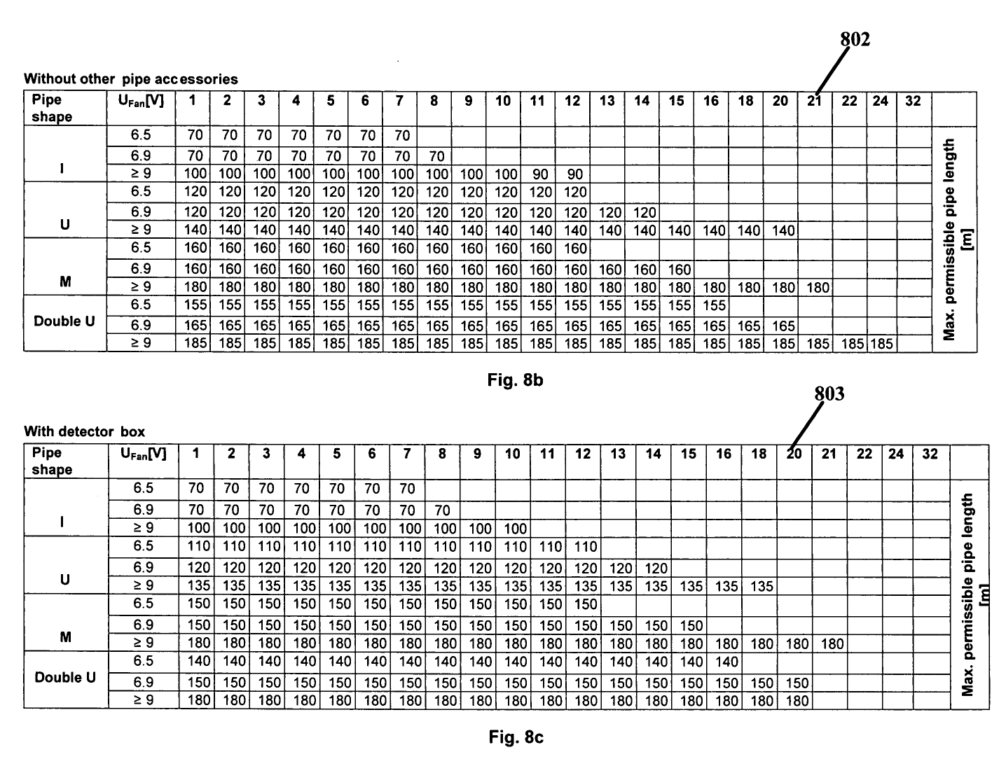

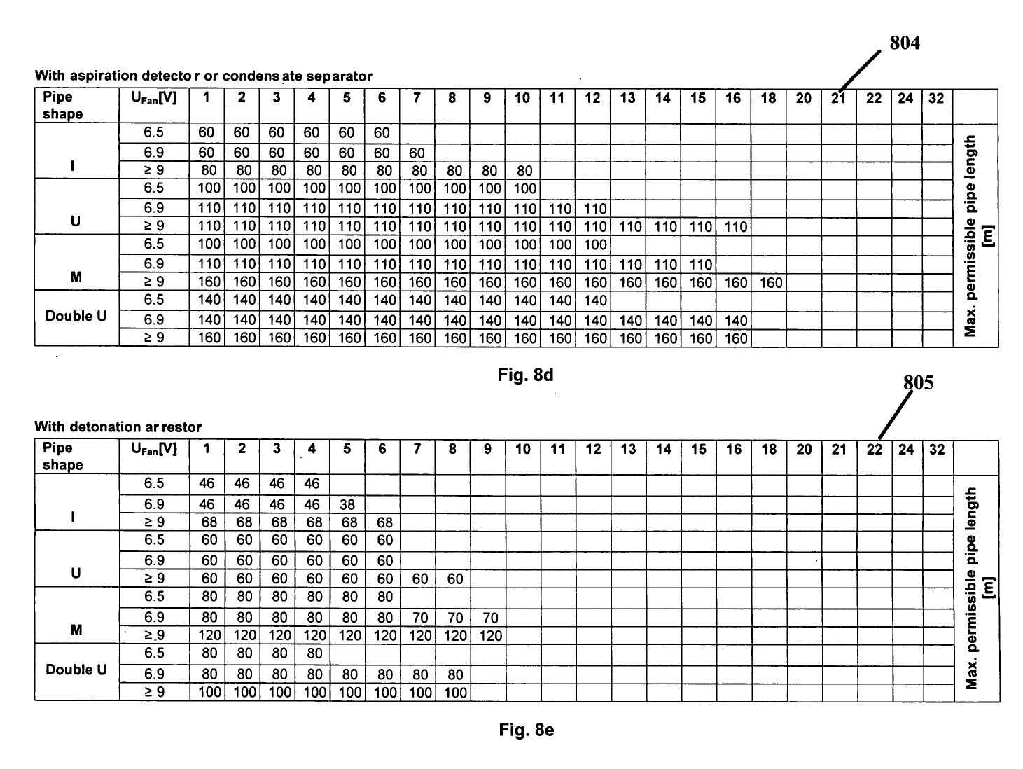

FIGS. 8a to 8e show further embodiments of a planning table 801 and pipe planning tables 802 to 805 which are to be used when either the SF-400 or the SF-650 air filter has been selected. Without any further pipe accessories, the pipe planning table 802 from FIG. 8b is to be used; with a detector box, pipe planning table 803 from FIG. 8c is to be used; with an aspiration detector and/or a condensate separator, pipe planning table 804 from FIG. 8d is to be used; and with a detonator arrestor, pipe planning table 805 from FIG. 8e is to be used.

A comparison of column 811 from FIG. 8a with column 401 from FIG. 4a shows that when using these particular air filters, only the DM-TT-01-L detector module can be used if there are eight intake openings provided. In so doing, the sensitivity setting must be at 0.015 or 0.3% light obscuration per meter.

Specified embodiments are purely for illustrative purposes and not to be regarded as limiting. There can be a number of deviations from a depicted embodiment without any departure from the inventive concept as indicated in the accompanying claims.

1. A method for planning an aspirative fire detection system having a detector module and a pipe system, wherein the method comprises the following steps:
planning the detector module with the aid of at least one planning table; and
planning the pipe system with the aid of at least one pipe planning table.

2. The method according to claim 1, wherein the step of planning the detector module comprises the following steps:
selecting a number of intake openings and
determining the achievable sensitivity classes (A, B, C) of the fire detection system based on the planning table and the number of intake openings.

3. The method according to claim 1, wherein the step of planning the detector module comprises the following steps:
selecting a desired sensitivity class and
determining the required responsivity for a detector module to achieve the desired sensitivity class.

4. The method according to claim 3, wherein the step of planning the detector module comprises the following steps:
selecting the detector module based on the required sensitivity and
determining a sensitivity setting for the detector module based on the detector module and the required sensitivity.

5. The method according to claim 1, further comprising the following steps:
selecting an air filter; and
determining a planning table and/or a pipe planning table based on the air filter.

6. The method according to claim 1, wherein the step of planning the pipe system comprises the following steps:
selecting a desired pipe length;
selecting a pipe shape based on the pipe length and the pipe planning table; and
selecting a fan voltage based on the pipe length and pipe shape.

7. The method according to claim 1, further comprising the following steps:
selecting a desired pipe accessory class; and
determining a pipe planning table based on the pipe accessory class.

8. The method according to claim 7, wherein the step of selecting a desired pipe accessory class comprises the following steps:
selecting one or more components from the component group comprising condensate separators, detonation arrestors, valve control unit shut-off valves, detector boxes, sound suppressors and aspiration detectors.

9. A device for planning an aspirative fire detection system having a detector module and a pipe system, wherein the device comprises the following:
means for planning the detector module with the aid of at least one planning table; and
means for planning the pipe system with the aid of at least one pipe planning table.

10. The device according to claim 9, wherein the device for planning the detector module comprises the following:
means for selecting a number of intake openings; and
means for determining the achievable sensitivity classes based on the planning table and the number of intake openings.

11. The device according to claim 9, wherein the device for planning the detector module comprises the following:
means for selecting a desired sensitivity class; and
means for determining a required responsivity for a detector module to achieve the desired sensitivity class.

12. The device according to claim 11, wherein the device for planning the detector module comprises the following:
means for selecting the detector module based on the required sensitivity; and
means for determining a sensitivity setting for the detector module based on the detector module and the required sensitivity.

13. The device according to claim 9 further comprising:
means for selecting an air filter; and
means for determining a planning table and/or a pipe planning table based on the air filter.

14. The device according to claim 9, wherein the means for planning the pipe system comprises the following:
means for selecting a desired pipe length
means for selecting a pipe shape based on the pipe length and the pipe planning table; and
means for selecting a fan voltage based on the pipe length and pipe shape.

15. The device according to claim 9 further comprising the following:
means for selecting a desired pipe accessory class; and
means for determining a pipe planning table based on the pipe accessory class.

16. The device according to claim 15, wherein the means for selecting a desired pipe accessory class comprises means for selecting one or more components from the component group comprising condensate separators, detonation arrestors, valve control unit shut-off valves, detector boxes, sound suppressors and aspiration detectors.

17. A computer program which includes instructions furnished to perform
a method for planning an aspirative fire detection system having a detector module and a pipe system, wherein the method comprises the following steps:
planning the detector module with the aid of at least one planning table;
and planning the pipe system with the aid of at least one pipe planning table; or
set up a device for planning an aspirative fire detection system having a detector module and a pipe system, wherein the device comprises the following:
means for planning the detector module with the aid of at least one planning table; and
means for planning the pipe system with the aid of at least one pipe planning table when run on a computer.
